(19) United States
(12) Patent Application Publication
(10) Pub. No.: US 2011/0082770 A1
(43) Pub. Date: Apr. 7, 2011

(54) User-Initiated Buyer-Vendor Match Search

(76) Inventors: Prabhakaran Krishnamoorthy, Bangalore Karnataka (IN); Uday Sankar Sen, Bangalore Karnataka (IN)

(21) Appl. No.: 12/574,410

(22) Filed: Oct. 6, 2009

(51) Int. Cl. G06Q 30/00

(52) U.S. Cl. 705/26.64

(57) ABSTRACT

A method and a system for a user-initiated vendor search are described. In one aspect, the system includes a mechanism for collecting purchase solicitations from the buyers and sale solicitations from the sellers. The purchase solicitations include information about the products/services sought by the buyers, while the sale solicitations include information about the products/services offered by the sellers to the buyers. In one aspect, upon receiving a purchase solicitation from a buyer, the system attempts to accommodate the request by matching the request for the products/services with the offers of the products/services offered by the sellers. Similarly, upon receiving a sale solicitation from a seller, the system provides the matching offers of the products/services the products/services sought by the buyers. The solicitations and the matches are advertised to the sellers and to the buyers using various schemes and schedules.

### FIELD OF THE INVENTION

The present invention relates to information management systems and, more specifically, to a machine-implemented agent-based architecture for a market place to supports sellers and buyers in their e-commerce pursuits.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

In very general terms, electronic commerce (“e-commerce”) is defined as buying and selling goods and services over the Internet. The concept of e-commerce is based on using the Internet to do business better and faster than it could have been done using traditional market places. E-commerce is about presenting the customers with controlled access to computer systems, servers and databases and allowing the customers to serve themselves.

E-commerce is based on an electronic exchange of business information using the Internet highway. For example, an electronic exchange may be conducted between users and the Internet based websites. The exchange may utilize e-mail systems, electronic bulletin boards, fax transmissions, encryption schemes for electronic funds transfer, etc. Usually, the electronic exchange refers to the Internet shopping, online stock and bond transactions, downloading files and applications, business-to-business transactions, etc.

Various companies, such as eBay Inc., Amazon Inc., Overstock Inc., Priceline Inc., Craigslist Inc., etc., have already taken an advantage of potential of e-commerce and developed electronic market places for the buyers and sellers.

However, as regular commerce, e-commerce deals with a variety of issues and difficulties. Some of the problems are related to finding and attracting customers to the place of business. Fortunately, at least partial solutions to these problems may be provided by well designed and executed marketing strategies, advertising campaigns, etc.

Other issues pertain to orders and payments processing. E-commerce transactions have to take place over electronic connections that are secure and that have access to secure merchant accounts and private information. Hence, various problems related to data security that surrounds online payments may arise even though they may not come into play in traditional commerce.

Other problems are related to reliability of the sellers (with regard to providing the requested products and services) and reliability of the buyers (with regard to fulfilling financial obligations after accepting the products and services). Although these problems are also characteristic to traditional commerce, they are amplified in e-commerce because of the nature of the transactions conducted over the Internet and because of lack of interpersonal interactions between the parties.

Over the years, various e-business models have been developed as e-commerce expands and entices more and more customers. For example, some of the business models are based on a concept of an “e-buyer-broker” and “e-seller-broker,” thus implying a separate representation of a buyer and a separate representation of a seller.

Other business models are based on a concept of an impartial intermediary, also called an e-negotiator, or an independent agent, who, on one hand, represents both the buyer and the seller and tries to negotiate the best “deal” for both of them, but on the other hand, expresses no favoritism of the buyer interests or the seller interest.

However, regardless of the model that is being implemented in a particular e-commerce approach, the issue of attracting to an e-market the buyers and sellers who are reliable and trustworthy remains as in traditional commerce.

Buyers and sellers may be drawn to the e-market place if the place is effectively advertised, publicized, etc. Various forms of advertisements, mailings, in person solicitations, phone solicitations, etc. are known and commonly used to advertise the electronic market place and the services. While one form of the advertisements may be more obtrusive than another, most of the time, advertising seems to be primarily driven by the sellers who are anxious to sell their products and their services. Consequently, the sellers may be more aggressive, insistent and adamant in their approaches than the buyers.

Some companies rely on specialized marketing departments to attract the customers. The goal of a marketing department is to increase the number of interactions with potential customers and ultimately increase the company revenue. Teams of the marketing departments may use various techniques, such as promotions, advertising, publicity campaigns, etc. The marketing departments may also work on expanding public relations, creating interests groups, organizing market fairs, symposia, conferences, etc.

In context of e-commerce, marketing departments may implemented various approaches to attract potential customers by developing company websites, providing electronic links pointing to products/services information, listing the company achievements and press releases, engaging in commerce using the Internet highway, expanding the company business circles and social networks via electronic media such as Twitter™, Facebook™, chatting rooms, blog boards, etc.

Nevertheless, the problem of finding the right buyers and the right sellers remains. Merchants are looking for other merchants who are not only interested in transacting of the same products/services, but who are also highly respected and well-regarded. Conducting business involves not only exchanging the goods and/or services, but also building trusting relationships. Both parties are hoping that the transaction will provide them with what they expect to receive from the exchange, and that the transaction will be free form fraudulent, incomprehensible or perplexing acts and events.

One approach to the search of “trustworthy” buyers and sellers is to enlist the reliable/trustworthy merchants and make the lists available to the public. For example, marketing departments may generate such lists, and use them for targeted advertisement, in person or phone contacts, networking, promotional campaigning, etc.

However, the above lists can be useful if the information that they present is current and updated systematically. Furthermore, the information included in the lists has to reflect the most current requirements and expectations.

But even if the information is up to date, due to the abundance of information that is being sent over the Internet, it may be difficult to find the sellers who offer the exact products that are sought by the buyers and to find the buyers who seek the exact products that are advertised by the sellers. The difficulties may be caused by aggressive sales tactics pursued by the sellers. For example, often marketing departments provide an overwhelming amount of information that the buyers are neither willing nor able to understand or absorb.

Another problem with product marketing relates to the time constraints. The buyers might want to find the appropriate sellers according to the buyers' time schedule, not when it is convenient to the sellers. For example, instead of facing an inundation of phone calls, advertisements, etc., the buyers might prefer spending very little time looking for the suitable sellers and might prefer finding the sellers only when it is convenient to the buyers. Thus, although the buyers might appreciate the circumstances in which the sellers are competing for the buyers' business, the buyers might prefer that the competition take place on the sellers' time, that only the results of the competition are communicated to the buyers and that the results are communicated to the buyers only when the buyers are interested in the results.

However, even if the sellers' offers are presented to the buyers according to the buyers' schedule, often the offers do not match the buyers' needs in the manner that the buyers have expected. For example, there might be issues of different standards applied by the buyers and the sellers, different certifications used by the merchants, or there might be some misunderstanding as to what was requested and what was provided.

Based on the foregoing, an approach for a user-initiated vendor search that does not suffer from the limitations in prior approaches is highly desirable.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that depicts a system for a user-initiated vendor search, in accordance with an embodiment of the invention;

FIG. 2 is a block diagram that depicts an exemplary user account, in accordance with an embodiment of the invention;

FIG. 3 is a block diagram that depicts an exemplary solicitation, in accordance with an embodiment of the invention;

FIG. 4 is a flow diagram that depicts an approach for a user-initiated vendor search, in accordance with an embodiment of the invention;

FIG. 5 is a flow diagram that depicts an approach for a user-initiated vendor search, in accordance with an embodiment of the invention; and

FIG. 6 is a block diagram that illustrates a computer system upon which an embodiment of the invention may be implemented.

### DETAILED DESCRIPTION

A method and a system for a user-initiated vendor search are described. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention. The invention is not limited to the particular order of steps depicted in the figures and the order may vary, depending upon the requirements of a particular implementation. Furthermore, steps that are depicted and described may be removed and/or other steps may be added, depending upon the requirements of a particular implementation. Various aspects of the invention are described hereinafter.

### General Overview

A method and a system for a user-initiated vendor search are described. In one aspect, the system includes a mechanism for collecting purchase solicitations from the buyers and collecting sale solicitations from the sellers. Purchase solicitations comprise information about the products and services being sought by the buyers. Sale solicitations comprise information about the products and services offered by the sellers. The solicitations may be stored in the system database.

In one aspect, upon receiving a purchase solicitation from a buyer, the system attempts to accommodate the request by matching the requested products and/or services with the products and/or services that have been already submitted to the database as offered by the sellers. If one or more matches between the requested products/services and already offered products/services is found, then the information about the matching products/services is provided to the respective buyer.

In one aspect, the purchase solicitation from the buyer is also sent to the sellers who are known as potential sellers of the requested products/services. This approach may be viewed as marketing of the demand for products and services that are sought by the buyers. The purchase solicitation may be sent to the sellers regardless of whether the particular products/services have not been already advertised by the sellers.

In one aspect, the purchase solicitations may be provided directly to the sellers. Alternatively, the purchase solicitations may be provided to a website that is easily accessible to the sellers. In turn, a particular seller may review the purchase solicitations and determine whether the seller has a capacity to meet the purchase requests. If so, then the particular seller may provide one or more sale solicitations to the system and have the system make the sale solicitations available to one or more buyers and/or communicate the sale solicitations directly to the respective buyers.

Upon receiving a sale solicitation from the seller, the system attempts to accommodate the request by matching the offered product and/or services with the product and/or services that have been already submitted to the database as requested by the buyers. If one or more matches between the offered products/services and already requested products/services is found, then the information about the matching products/services is provided to the respective seller.

In one aspect, the sale solicitation from the seller is also sent to the buyers who are known as potential buyers of the offered products/services. This approach may be viewed as marketing of the supply for products and services that the sellers are offering to the buyers but at the moment have not been sought by the buyers. The sale solicitations may be provided directly to the buyers or provided to a website that is easily accessible to the buyers. In turn, the buyers may review the sale solicitations and determine whether they have interest in the offered products or services. If so, then the buyers may provide purchase solicitations to the system and have the system make the purchase solicitations available to the sellers or communicate the purchase solicitations directly to the sellers.

Solicitation may comprise keywords, key phrases, a free form text, or both. Alternatively, or in addition to, the solicitation may comprise information selected from a menu or a catalog provided by the system.

In one aspect, the solicitation may be represented as a query sent to the system. The query may be processed by the system to identify the products and/or services that are either being sought or offered, and to identify additional attributes of the products/services. While processing the query, the system reviews the information already provided to the system by other users that is about the products and services that other users have already “solicited” to the system. Based on that information, the system selects the products and/services that exactly or at least partially match the request in the query. The selected results are provided to the user as search results.

In one aspect, execution of the query may be repeated in some later time. For example, the query may be re-executed periodically when new users register with the system, when new solicitations are received by the system, etc. Re-execution of the query may generate a new set of search results, which can be delivered to the user as “additional search results.”

All the search results, including the additional search results, may be emailed to the users or made available to the users via a website. The search results may be also available to other users to invite them to place their solicitations for the products/services offered by the sellers and sought by buyers.

Buyers may provide their feedback regarding interactions with the sellers, quality of the delivered products/services, etc. The buyers may also provide ratings of the sellers, the sellers' promptness, etc. The buyers may also provide ratings of the quality of services provided by the seller-buyer agent, the adequacy of the match between the buyers' needs and the offered products, etc.

In one aspect, the sellers may provide their feedback regarding interactions with the buyers, quality of the shipped products/services, etc. The sellers may also provide ratings of the buyers, the buyers' promptness, the buyers' ability to fulfill their financial obligations, etc. The sellers may also provide ratings of the quality of services provided by the seller-buyer agent, the adequacy of the match between the sellers' offers and the sought products, etc.

### System Architecture Overview

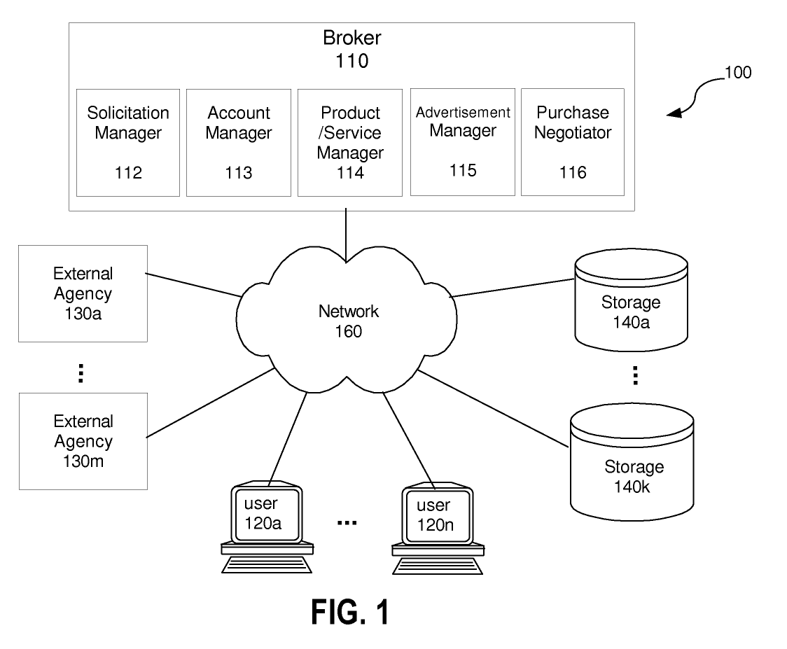

FIG. 1 is a block diagram that depicts a system 100 for a user-initiated vendor search, in accordance with an embodiment of the invention. System 100 comprises a broker 110, one or more storage devices 140a . . . , 140k, one or more users 120a . . . , 120n and one or more external agencies 130a . . . , 130m. Users 120a . . . , 120n may be connected to a computer network 160, and may communicate over computer network 160 with each other, with various websites, with broker 110 and/or with one or more external agencies 130a . . . , 130m.

Broker 110 is a facilitator, an agent and an intermediary who brings the merchants to the electronic market place. Broker 110 links the users-consumers to the users-vendors, where the users-consumers are the users who seek products and/or services, while the users-vendors are the users who offer products and/services to the consumers.

In one aspect, broker 110 may comprise various modules. For example, broker 110 may comprise a solicitation manager 112, an account manager 113, a product/service manager 114, an advertisement manager 115 and a purchase negotiator 116. (Described below)

According to one embodiment, broker 110 may be implemented as a server application residing on a server device and made available to the users over the Internet. According to another embodiment, broker 110 may be implemented as a feature available via a website portal. For example, broker 110 may be implemented on the Yahoo!™ website and available to the users my.yahoo.com, etc, or any other website. Alternatively, broker 110 may be implemented as an independent web site.

In one aspect, functions performed by broker 110 include bringing the sellers to the purchasers, developing a network of trustworthy purchasers and trustworthy sellers, receiving feedback from the merchants about the transactions, products, services, other merchants, etc.

Furthermore, broker 110 provides a focus on the quality of the transacted products and services, provides a convenient and unobtrusive way for connecting the buyers with the sellers, and allows the merchants to participate in the electronic market place according to the merchants' own schedule and when it is convenient to them.

In one aspect, broker 110 manages the information provided by the merchants, updates information stored in storage 140a . . . , 140k associated with broker 110, performs merging and integrity checks of the stored data, as well as ranking of the participating merchants. Furthermore, broker 110 manages data security and merchant accounts, and protects the system from spam, viruses and unwanted attacks.

Computer network 160 may be any type of the network facilitating communications between the users and providing the Internet services to the users. For example, computer network 160 may be an Internet network to which users 120a . . . , 120n connect via service provider's equipment, modems, telephone lines, etc.

In one aspect, computer network 160 may be a local network, or a wide area network, communicatively coupled with the Internet. Alternatively, computer network 160 may be not just one network, but a meta-network of various heterogeneous networks communicating with each other using various communications protocols and offering various services.

External agencies 130a . . . , 130m may act as actual brokers between the buyers and the sellers. Examples of such agencies may include eBay Inc., Amazon Inc., Overstock Inc., Priceline Inc., Craigslist Inc., etc. The users have a choice as to which external agency they would like to use. Each of the external agencies may be a site or an organization that can create a marketplace in addition to the marketplace created by broker 110.

### Users

In one aspect, users 120a . . . , 120n are users who access computer network 160 via any type of an electronic device using any type of service from any type of service provider. For example, users 120a . . . , 120n may access computer network 160 from computer workstations, laptops, mainframe computers, personal digital assistant devices, etc., and may connect with the Internet using various technologies, various equipment and various communication protocols. Users 120a . . . , 120n may communicate with other users and other entities using chats, emails, voice over IP (VoIP™), webinars, web meetings, webcam sessions, etc.

Users 120a . . . , 120n may communicate with others as anonymous users using anonymous accounts or identifiers. Alternatively, users 120a . . . , 120n may have individual accounts. (Described below)

Users 120a . . . , 120n may retrieve pages from various websites. For example, users 120a . . . , 120n may load web pages into their browsers, perform document searches using the browsers, write documents, post the documents, launch various applications over the Internet, etc.

Users 120a . . . , 120n may communicate with other entities in the system using various communication protocols and using various tools. For example, the users may use Hypertext Transfer Protocol (HTTP), Transport Control Protocol/Internet Protocol (TCP/IP), Ethernet, etc. to communicate with other entities over the network.

Furthermore, the users may use browsers, email servers and other applications configured to facilitate communications between the users and other entities residing on the network. For example, email communications maybe based on an e-mail client implemented on the user device and configured to send and receive e-mail messages according to an e-mail protocol. In particular, an e-mail client implemented in user device 120a may be configured to receive information from programs resident on other user devices (e.g. 120n), programs resident on broker device 110, programs resident on external agencies 130a . . . , 130m, etc., and to send that information in the form of e-mail messages to e-mail servers. The email client implemented in any of user devices 120a . . . , 120n may also send information to programs resident on other user devices, broker 110, external agencies 130a . . . , 130m, etc.

In one aspect, users 120a . . . , 120n may be buyers, sellers or both. For example, in one transaction, a user may assume a role of a buyer because the user may send to the system a purchase solicitation to request certain products and/or certain services. However, in some other transaction, the same user may assume a role of a seller because the user may send to the system a sale solicitation to offer certain products and/or certain services to other users.

The users may switch their roles with respect to different transactions, different time intervals and different parties. For example, the user “U1” may act as a buyer of a particular product offered by the user “U2,” but at the same time, the user “U1” may act as a seller of another (or the same) product to the user “U3.” According to another example, the user “U1” may be a buyer of some products from the user “U2,” but a seller of some other products to the user “U2.” Other arrangements of relationships between the users in terms of assuming the roles of a buyer and/or a seller are also contemplated.

### Consumers and Vendors

In one aspect, a user is a consumer if the user “consumes” the goods obtainable via the market place. For example, a consumer may “consume” the goods by using the information available via broker 110, purchasing the goods advertised by broker 110, selling the goods using broker 110, etc. According to another example, a user is a consumer if the user submits a purchase solicitation by which the user manifests that the user is willing to purchase a particular product, service, or both. The user is also a consumer if the user receives solicitations from other users via the broker. Another example of a consumer is the user who decided to act upon the received solicitations and initiated purchase negotiations with another merchant using the broker. The user is also a consumer if the user just browses the information available via the broker without actually requesting any products, offering any products or transacting with any other user.

In one aspect, a user is a vendor if the user responds to the requests submitted to the system by other users. For example, the user who offers products and/or services and sends sale solicitations to the broker may be considered a vendor. According to another example, the user who advertised the products with the broker may be considered a vendor. Also, the user who after reviewing purchase solicitations provided by other users, decided to submit sale solicitations corresponding to the purchase solicitations already entered into the broker system may be considered a vendor.

Although not every purchaser who interacts with the broker has to be a customer and not every seller who interacts with the broker has to be a vendor, for simplicity, it may be assumed that it is such a case. In practice, however, one user may be a customer in some transactions, but a vendor in some other transactions.

In one aspect, roles of the consumers and/or vendors may be assigned to the users by the broker. For example, if the broker processes a particular purchase solicitation, then the users who responded to the particular purchase solicitation and/or who provided sale solicitations that match the particular purchase solicitation may be treated by the broker as vendors. By analogy, if the broker processes a particular sale solicitation, then the users who responded to the particular sale solicitation and/or who provided purchase solicitations that match the particular sale solicitation may be treated by the broker as consumers.

### Buyers and Sellers

In one aspect, users 120a . . . , 120n are buyers or sellers, or both. For example, the users who are interested in purchasing products or services via broker 110 become buyers. They do not have to actually conduct purchase negotiations and do not have to actually purchase any product or service via broker 110. It is sufficient that they express interest in purchasing products/services by browsing the menu of products/services provided by broker 110, by submitting one or more purchase solicitations, by creating an account with broker 110 and identifying themselves as “purchasers,” by advertising themselves to broker 110 as purchasers, etc.

In one aspect, the users who are interested in selling products or services via broker 110 become sellers. They do not have to actually conduct sale negotiations and do not have to actually sell any product or service via broker 110. It is sufficient that they express interest in selling products/services by browsing the menu of products/services provided by broker 110, by submitting one or more sale solicitations, by creating an account and identifying themselves as “sellers,” by advertising themselves as sellers, etc.

In one aspect, some of users 120a . . . , 120n are neither actual buyers nor actual sellers. According to one embodiment, some of the users may be just interested in knowing what products and/or services are being advertised by broker 110. In fact, none of the users 120a . . . , 120n has to submit a purchase solicitation or a sale solicitation. Each of the users may just browse the information about the solicitations submitted to broker 110, and stored in the system storage 140a . . . , 140k.

### Storage

Storage devices 140a . . . , 140k may be implemented as database servers. A database server is a program that is configured to receive database commands from other programs. The database may be configured to execute various database commands, such as, storing data to the storage, modifying data stored in the storage, retrieving data from the storage, etc. For example, database commands may take the form of Structured Query Language (SQL) statements. The database servers may be managed centrally by broker 110 or by one of the storage devices 140a . . . , 140k. Alternatively, each of the storage devices 140a . . . , 140k may be managed locally and separately.

Storage devices 140a . . . , 140k may store information about one or more buyer accounts and one or more seller accounts. Each of the users 120a . . . , 120n may be associated with one or more buyer accounts and/or one or more seller accounts. Among other information, each account may be associated with a separate username, password, and an account type that indicates whether that account is a buyer account or a seller account. For each account, the storage may store a separate set of information items that are associated with that account. The set of information items associated with a particular account may vary depending on the account type.

Storage devices 140a . . . , 140k may store information about purchase solicitations, sale solicitations, matches between the purchase solicitations and sale solicitations, advertisement information, products/service ranking and statistics information, etc.

### Account Manager

In one aspect, the main function of account manager 113 is to manage user accounts. Each user who communicates with broker 110 has an option of requesting and creating a user account. Some users may choose never to apply for a user account, while others may request a user account during the first interaction with broker 110.

The users do not need to have user accounts. The user may view menus, catalogs, solicitations, statistics, and other information available via broker 110 without having an actual account. The users do not have to login to the system to initiate a search, to enter solicitations to the system, to request information about products offered and requested by the user of the system, etc. However, if the users want to have the search results sent to them offline, or have the search results available to them at some later time, then the users may be required to create user accounts and provide login information.

Furthermore, the users who have accounts may receive services that are customized to the users needs with a higher level of accuracy than the users who do not have user accounts. For example, a user who creates a user account, may provide the system with his preferences, which otherwise may not be specified in a subsequently submitted solicitation. In such a case, the system may provide such a user with more accurate search results and may provide the search results in the exact form that the user requested.

According to another example, the user who creates a user account may provide additional preferences and attributes of the products that he offers or seeks even if such attributes are not specified in the subsequently submitted solicitation. The preferences and attributes stored in the user accounts allow the broker to provide the users with more accurate responses to the solicitations and allow the broker to better satisfy the users' expectations.

In one aspect, various types of information may be stored in the user account. For example, if the user chooses to register with the system, then the user may be asked to create a user login (i.e. user identifier), user password, etc., specify an account type, provide user email address, etc. If applicable, the user may also provide the company name, company address, phone numbers, certification licenses, etc. The user may also specify the names of the products he is interested in, the preferences, etc.

The system may also add, to the user account information, the user IP address, the date the user account was created, etc. Furthermore, as the user continues to use the broker services, the system may update the dates indicating when the user used the system, the type of solicitations and/or transactions that the user submitted, etc.

In one aspect, the user account may also store information submitted by other users. For example, the user account of a particular user may contain information on how other users rated the transactions conducted with the particular user, how other users rated the products or services offered by the particular user, how reliable or trustworthy the particular user was, etc.

In one aspect, account manager 113 periodically checks the account database integrity, updates the outdated records, deletes the accounts that expired or are duplicative, etc.

In one aspect, account manager 113 is responsible for authorization and authentication of the users who attempt to access and use their accounts. Various schemes of authentication and authorization may be implemented. For example, the authorization and/or authentication may be based on verifying whether the provided user-login/user-password combination is correct. The authorization may be also based on verifying whether the user provided the correct secret code, correct data string or text, etc. The authorization may be also based on verifying whether the user correctly answer a question posed by account manager 113, etc.

### Accounts

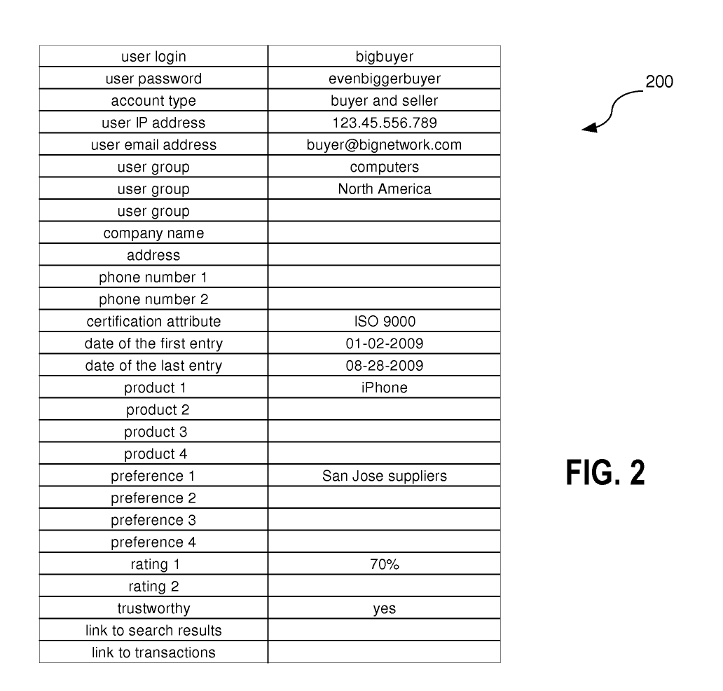

FIG. 2 is a block diagram that depicts an exemplary user account 200, in accordance with an embodiment of the invention. The users do not have to have user accounts. For example, the users may view the menu, the solicitations, statistics, and other information available via broker 110 without having actual user account. Furthermore, the users do not need to have user accounts to initiate searches, to enter solicitations to the system, to request information about products offered and requested by other users, etc. However, if the users want to have the search results sent to them offline, to be sent to them at some later time, etc., then the users may be required to create their accounts and provide login information.

In one aspect, if the user chooses to register with the system, then the user will be prompted to create a user account. As depicted in FIG. 2, an exemplary user account 200 may be organized as a data structure such as a table comprising an ordered pairs containing data. Alternatively, a user account may be organized as a data structure such as a list with pointers to the storage locations where additional information is stored.

According to FIG. 2, the user account data structure comprises a table containing pairs of data elements. The first element of the pair contains the name of the parameter, whereas the second element of the pair contains the value of the corresponding parameter. The value of the parameter may consist of an alpha-numeric string, a character string, a numerical value, a toggle, etc.

In one aspect, the user may be asked to enter some of the values of the parameters stored in the user account. For example, the user may be asked to enter the user login name, the user password, the user email address, the name of the user company, the user address, etc. If applicable, the user may be also prompted to provide phone number(s), certification license(s), etc. In addition, the user may be asked to indicate whether he is a buyer or a seller.

As depicted in FIG. 2, the user created an account with the user login “bigbuyer” and the user password “evenbiggerbuyer.” The user specified that the user's account type is “buyer,” and that the email address is buyer at bignetwork.com. The user also provided information that indicates that his company is ISO 9000 compliant

In one aspect, the user may specify the names of the products in which he is interested, his preferences, etc. For example, the user may be prompted to enter the names of the products which he is willing to sell or to buy. The names of the products may be entered as a free form text and according with the rules of constructions, such as the length of the free form text, the language, etc.

Alternatively, the system may display, for the user, a list or a menu of products. The system may allow the user to choose a certain number of products from the menu. The menu may be displayed to the user as the user follows the process of creating the account. The menu may be displayed as a pull-down menu.

In one aspect, the user may be prompted to enter one or more preferences. A preference may pertain to the geographical location of the market place in which the user usually conducts the business. The preference may pertain to the names of vendors with whom the user wishes to interact, the names of groups to which the user wishes to belong, etc.

As depicted in FIG. 2, the user specified that the user wants to belong to the user groups called “computers,” and “North America,” and is interested in an “iPhone,” from the suppliers in the San Jose area.

The system may also add to the user account information about the user IP address, the date the user account was created, etc. Furthermore, as the user continues to use the broker services, the system may update the date when the user made the last entry to the system, the type of solicitations and/or transactions that the user submitted, etc.

As depicted in FIG. 2, the system identified and added, to the user account, the user IP address “123.45.556.789,” the date of the first entry as “Jan. 2, 2009,” and the date of the last entry as “Aug. 28, 2009.”

In one aspect, the user account may also store information submitted by other users. For example, the user account of a particular user may contain information on how other users rated the transactions conducted with the particular user, how other users rated the products or services offered by the particular user, how reliable and trustworthy the particular user was, etc.

According to FIG. 2, the user has been rated at least by one other user, and the entered rating is “70%.” The rating of a particular user may be interpreted as a confidence level that other user or users expressed after transacting with the particular user. For example, the rating 100% means that other users perceive the particular user as completely reliable and that other users have never complained about the particular user or the transactions conducted with the particular user. In contrast, the rating 0% means that other users do not have confidence in transacting with the particular user. The rating of 75% is good, but not excellent.

In one aspect, other users may submit to the system information indicating whether the particular user is trustworthy. The information about trustworthiness may be entered using a pull-down menu or a toggle displayed for the user. According to FIG. 2, one or more other users believe that the particular user is “trustworthy,” and that information was entered to the account of the particular user.

In one aspect, the user account may contain one or more links to search results available to the user. For example, if the user submitted a purchase solicitation, requested that broker 110 performs search for matching sale solicitation and indicated that the search results should be provided offline, then the system will perform the requested search, collect the results, store the search results in storage 140a . . . , 140k and enter an electronic link to the user account. The link may be a pointer indicating the location in the storage 140a . . . , 140k where the particular search results are stored.

In one aspect, the user account may contain one or more links to information about transactions that the user-initiated or already completed. For example, if the user accepted one or more sale offers submitted to the user in response to the user purchase solicitation, and if the user-initiated purchase negotiation related to a particular sale offer, then the information about the transaction may be stored in storage 140a . . . , 140k, and the link to the information stored in the storage may be entered to the user account. The link may be a pointer indicating the location in the storage 140a . . . , 140k where the information about the particular transaction is stored.

In one aspect, the user accounts are stored in storage 140a . . . , 140k and maintained by account manager 113. Account manager 113 periodically checks the account database integrity, updates the outdated records, deletes accounts that expired or are duplicative, etc.

In one aspect, the information stored in the user accounts is used to authorize and authenticate the users who attempt to access and use their accounts. Various schemes of authentication and authorization may be implemented. For example, the authorization and/or authentication may be based on verifying whether the provided user-login/user-password combination is correct.

In one aspect, the user may customize own account. For example, the user may add new criteria to the account. The user may also add new value types for a criterion. For example, if the drop-down menu does not have a required option or value, the user may add a new value to the drop-down menu values. The customized new criteria and new values may be applicable only to the particular user, and not to other users. However, the system may be able to process the customized users' accounts and use the customized information.

### Solicitation Manager

In one aspect, the primary function of solicitation manager 112 is to manage purchase solicitations received from the buyers and sale solicitations received from the sellers. Each of the purchase solicitations may pertain to one or more products and/or one or more services that the buyer would like to buy via the broker. A solicitation may be quite specific as to the type of the product/service, or may be contain quite vague terms. The solicitation may be entered as keywords, key phrases, a free form text, or as a set of selections from a menu provided to the user by the broker.

In one aspect, solicitation manager 112 may organize the solicitations based on their types, categories, subcategories, etc. For example, the received solicitations may be first divided into two groups. The first group may contain the purchase solicitations, while the second group may contain the sale solicitations. Subsequently, each of the groups may be divided into a subgroup pertaining to products and a subgroup pertaining to services. Then, each of the subgroups may be divided based on a subcategory, attributes associated with the items, etc.

According to another example, the received solicitations may be first divided into a group pertaining to products and a group pertaining to services. Then, each of the groups may be divided into subgroups based on the attributes associated with the items. Subsequently, each of the subgroup may be further divided depending on whether the solicitation pertained to a purchase or to a sale. Other methods of organizing the solicitations are also contemplated.

In one aspect, the solicitations are stored in storage 140a . . . , 140k. The storage may be local to the broker, or may be accessible to solicitation manager 112 over the Internet as it is depicted in FIG. 1.

In one aspect, the solicitations stored in the storage are indexed by an associated index. The purpose of the index is to provide an efficient guide to the organization of the solicitations maintained by solicitation manager 112. The index may be organized based on the names of the categories, subcategories, attributes, etc. of the solicitations. The index may be stored along with the solicitations in storage 140a . . . , 140k, or may be stored separately from storage 140a . . . , 140k.

In one aspect, upon receiving a solicitation from the user, solicitation manager 112 parses the solicitation into components, identifies keywords and key phrases in the solicitation and uses the identified keywords and phrases to search the index and eventually to store the received solicitation in a proper group, subgroup etc. in storage 140a . . . , 140k.

In one aspect, upon receiving a request to view the solicitation database, solicitation manager 112 uses the index to prepare a template comprising names of the product/service categories, subcategories, attributes, etc., retrieves the information about the solicitations from storage 140a . . . , 140k and provides the information about the solicitations organized according to the template structure.

The information about the solicitation may be displayed to the user in a browser, may be emailed to the user, sent to the user's pager, mobile device, PDA, etc. The information about the solicitation may be organized as a table, as a list, or in any other form that is communicative and easy to review.

Solicitation manger 112 may also provide a listing containing the “best deals” provided to the users, a history of the submitted solicitations, search results, deals, etc. In addition, the users could set an alert to request a notification about particular “deals,” the “best deals,” etc.

In one aspect, solicitation manager 112 performs periodical maintenance of the database stored in storage 140a . . . , 140k. For example, solicitation manager 112 may periodically purge records that are inactive. Furthermore, solicitation manager 112 may periodically test whether any information is redundant and test integrity of the database. Solicitation manager 112 may also remove the data records that correspond to the users who are not using the system anymore, whose accounts expired or whose accounts were deleted. Also, solicitation manager 112 may periodically review the information stored in the database to detect spam, virus attacks, etc.

In one aspect, solicitation manager 112 may also generate and maintain a menu of the products and services managed by the broker. For example, the menu may be generated based on the information provided in the solicitations sent to the broker. The solicitations may be parsed to identify products, services, categories, providers, quality, quantity and other attributes specific to the particular products and particular services.

The menu may also be generated based on the information created by solicitation manager 112 independently from the information provided in the solicitations. For example, solicitation manager 112 may create the menu based on commercially available catalogs, information sent by the sellers and buyers directly to the broker or published by the sellers and the buyers in various publications, bulletin boards, websites, etc. According to another example, solicitation manager 112 may create the menu based on the products/services that the users registered with the broker.

In one aspect, the menu may be available to the users who access the broker services. The menu may be available not only to actual buyers or sellers, but also to the users who just browse the product/services database associated with the broker but have not purchased or sold any product/service yet.

The menu and the solicitation database may be updated periodically, and/or each time a new solicitation or any form of product/service related information is submitted to the broker.

### Solicitations

In one aspect, the users may submit to the system purchase solicitations and/or sale solicitations. A purchase solicitation may pertain to one or more products and/or one or more services that the buyer would like to buy via the broker, whereas a sale solicitation may pertain to one or more products and/or one or more services that the seller would like to sell via the broker.

A solicitation may be quite specific as to the type of the product/service, or may be contain quite vague terms. For example, the solicitation may be entered as a free form text or may be provided as a file uploaded by the user to the system. The received free form text or a file comprising a free form text is parsed by solicitation manager 112 to identify the names of the products, the attributes of the products and any additional information that may be useful in processing the solicitations.

Various methods and approaches may be applied by solicitation manager 112 to parse the received solicitation. For example, solicitation manager 112 may use machine-learned parsers that gather information about the keywords, key phrases and frequency with which various constructions occur in specific context; identify the keywords and key phrases; build a database of keywords, key phrases and associated attributes; and refer to the database to identify corresponding keywords and key phrases in the particular solicitation.

Other parsers may include probabilistic, context-free grammar parsers that refer to a database containing keywords and phrases while searching for keywords and phrases in the particular solicitation.

Other parsers may include parsers based on neural networks approaches or heuristic approaches. The parsers may be implemented in Java scripts, software applications, machine languages, database languages, and as components of other tools.

In one aspect, solicitation manager 112 parses a particular solicitation and identifies the products solicited by the user. Solicitation manager 112 may also identify a set of attributes associated with the solicited product. For example, if the user submitted a purchase solicitation for one ton of prime quality, red delicious apples at the price not exceeding $555 per ton, then the solicitation may be parsed to identify the following elements: 1) category (produce), 2) subcategory 1 (apple), 3) subcategory 2 (red delicious), 4) quality (prime quality), 5) quantity (one ton), 6) price ($555/ton).

According to another example, the user might submit a sale solicitation for one hundred iPhones 3GS with 32 GB memory having a black case and manufactured by Apple Inc., preferably supplied by Fry's Electronics, delivered any time but no later than on May 5, 2010. The parser may identify the following elements: 1) category (electronics), 2) subcategory 1 (phones) 3) subcategory 2 (iPhone), 4) model (iPhone 3GS), 5) manufacturer (Apple Inc.) 6) attribute 1 (3GS) 7) attribute 2 (32 GB), 8) attribute 3 (black), 9) preferred supplier (Apple Inc.), 10) quantity (100), 11) price ($199), 12) delivery (any time), 13) solicitation expiration date (May 5, 2010).

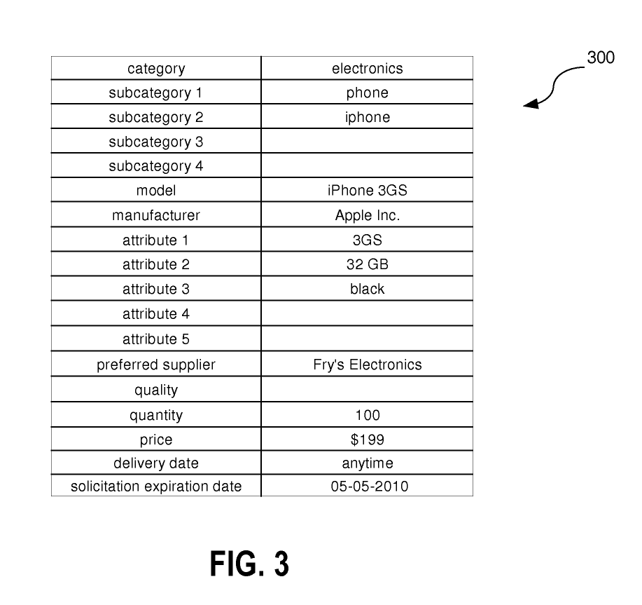

FIG. 3 is a block diagram that depicts an exemplary solicitation 300, in accordance with an embodiment of the invention. According to FIG. 3, the sale solicitation for one hundred iPhones 3GS with 32 GB memory having a black case and manufactured by Apple Inc., preferably supplied by Fry's Electronics, delivered any time but no later than on May 5, 2010, may be stored in a table comprising the following parameter pairs:

{category; electronics}

{subcategory 1; phones}

{subcategory 2; iPhone}

{subcategory 3; blank}

{subcategory 4; blank}

{model; iPhone 3GS}

{manufacturer; Apple Inc.}

{attribute 1; 3GS}

{attribute 2; 32 GB}

{attribute 3; black}

{attribute 4; blank}

{attribute 5; blank}

{preferred supplier; Apple Inc.}

{quantity; 100}

{price; $199}

{delivery date; any time}

{solicitation expiration date; May 5, 2010}

where the first element in each pair consists of the name of the particular parameter, and the second element in each pair consists of the value of the parameter.

In one aspect, if the particular solicitation does not provide values of certain attributes/parameters or the parser could not identify such values in the particular solicitation, then the solicitation manager 112 may assign default values to those attributes or parameters. For example, if the price is not specified, then solicitation manager 112 may assign the default value as “the best offer” to the parameter called “price.” According to another example, if the time of the delivery is not specified, then solicitation manager 112 may assign the default value as “anytime” to the parameter called “delivery.”

The default values may be generated by a module called an “Automatic Criteria Generator” (ACG). Capabilities of the ACG may vary and may depend on specific implementation of the system. However, the objective of the ACG is to eliminate or at least minimize a need for manual parsing of the received solicitations as the manual parsing most likely is time consuming, cumbersome, and ineffective

In one aspect, the solicitation may be entered to the system using a menu provided to the user by the broker. In such a situation, the user is prompted to enter values of the parameters. For example, the system may display a menu of the categories and subcategories of products and services and allow the user to select the products and/or services from the menu. While making the selection, the user may be prompted to indicate whether the particular product is being sought by the user or whether the particular product is to be sold. Furthermore, the user may be prompted to specify other applicable parameters, such as the model, the manufacturer, preferred supplier, quality, quantity, price, delivery date, solicitation expiration date, etc.

### Product/Service Manager

In one aspect, the main function of product/service manager 114 is to process purchase solicitations and sale solicitations. While solicitation manager 112 focuses on organizing and storing the received purchase solicitations and the received sale solicitations, product/service manager 114 actually processes the solicitations and tries to find matches between the purchase solicitations and the sale solicitations already stored in storage 140a . . . , 140k.

In one aspect, product/service manager 114 processes the solicitations one at the time or in batches using parallel processing. Further, processing of the solicitations may be performed in a push and pull modes. For example, for a particular purchase solicitation that was already received by the broker and stored in the storage by solicitation manager 112, product/service manager 114 tries to determine whether there is one or more sale solicitations that match the requested product/service specified in the particular purchase solicitation. In order to find the match, the information about the product/service specified in the particular purchase solicitation is tested against the information about product/services included in the sale solicitations already received and stored in the storage by solicitation manager 112.

If such a match is found, then product/service manager 114 provides the matching sale solicitations to the buyer who submitted the particular purchase solicitation. The search continues until all the sale solicitations that are stored in the storage are examined. If the search returns no matches, then a message summarizing lack of the matching sale offers at the particular moment in time may be sent to the respective buyer.

Similar steps are performed in case of processing of a sale solicitation. For a particular sale solicitation that was already received by the broker and stored in the storage by solicitation manager 112, product/service manager 114 tries to determine whether there is one or more purchase solicitations that match the offered product/service specified in the particular sale solicitation. In order to find the match, the information about the offered product/service specified in the particular sale solicitation is tested against the information about product/services included in the purchase solicitations already received and stored in the storage by solicitation manager 112.

If such a match is found, then product/service manager 114 provides the matching purchase solicitations to the seller who submitted the particular sale solicitation. The search continues until all the purchase solicitations that are stored in the storage are examined. If the search returns no matches, then a message summarizing lack of the matching purchase offers at the particular moment in time may be sent to the seller.

The sellers and the buyers may be notified about the results of the search immediately or according to a schedule provided by the sellers and the buyers. For example, the results of the search may be provided online, may be emailed to the user, or may be stored along with the user account and made available to the user when the user decides to log in into the system some time in the future.

In one aspect, product/service manager 114 sends the received solicitations to other users. For example, if a particular purchase solicitation was received from a particular buyer, then, regardless of whether any match has been already provided to the particular buyer, the particular purchase solicitation may be sent to the sellers to let them know that particular product/service is in demand, to encourage them to submit sale solicitation which otherwise might have not been submitted, to advertise to other buyers or “visitors” that the particular products/services have been requested, etc. The particular purchase solicitation may be disseminated to others in the form of an advertisement, mass emailing, individual emailing, posting on a bulletin board, etc.

In one aspect, the particular sale solicitation may be disseminated to other users regardless of whether any match has been provided to the particular seller who submitted the particular sale solicitation.

Advertisements of the purchase solicitations and sale solicitations may generate responses in the form of corresponding additional sale solicitations and corresponding additional purchase solicitations. After a specified period of time elapses or if a predetermined amount of additional sale solicitations and additional purchase solicitations is received, product/service manager 114 may repeat the matching routine for each already submitted purchase solicitation and each already submitted sale solicitation to determine whether any additional match may be found.

If one or more additional matches are found, then the matches are sent to the respective parties.

In addition, the information about the matches may be communicated to account manager 115 to update the users account. Also the information about the matches may be communicated to solicitation manager 112 to update the solicitation database stored in storage 140a . . . , 140k.

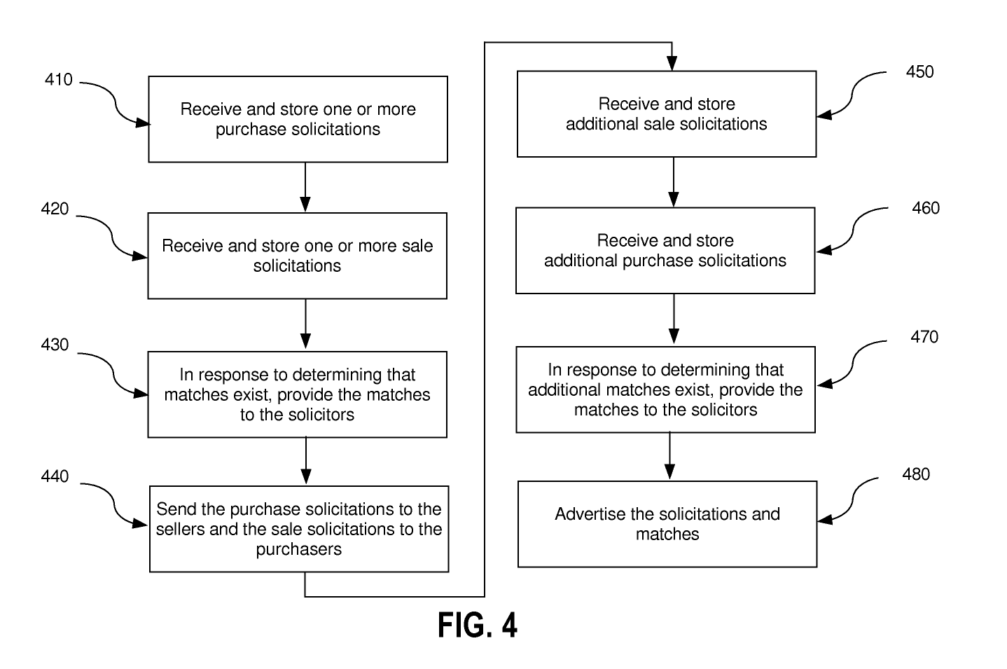

FIG. 4 is a flow diagram that depicts an approach for a user-initiated vendor search, in accordance with an embodiment of the invention. According to FIG. 4, in step 410, product/service manager 114 receives purchase solicitations from buyers and stores the received purchase solicitations in storage 140a . . . , 140k.

In step 420, product/service manager 114 receives sale solicitations from one or more sellers and stores the received sale solicitations in storage 140a . . . , 140k.

In step 430, product/service manager 114 determines whether, for a particular purchase solicitation submitted by the particular buyer, any matching sale solicitation may be found. In order to find a match, product/service manager 114 retrieves information about sale solicitations submitted to the system and stored in the storage 140a . . . , 140k, and verifies whether any of the sale solicitations contains the product/services identified in the particular purchase solicitation. If the match is found, then the match information is sent to the particular buyer who submitted the particular purchase solicitation. Product/service manager 114 repeats this routing for every purchase solicitation stored in the storage 140a . . . , 140k.

In the same step, product/service manager 114 also determines whether, for a particular sale solicitation submitted by the particular seller, any matching purchase solicitation may be found. In order to find a match, product/service manager 114 retrieves information about purchase solicitations submitted to the system and stored in the storage, and verifies whether any of the sale solicitations contains the product/services identified in the particular sale solicitation. If the match is found to the particular sale solicitation, then the matching purchase solicitation information is sent to the particular seller who submitted the particular sale solicitation. Product/service manager 114 repeats this routing for every sale solicitation stored in the storage.

In step 440, product/service manager 114 sends the received purchase solicitations to the sellers known to the broker. The distribution of the received purchase solicitations may be directed to a specific group of sellers, such as the group of sellers who specialize in the particular products or services, who are located in the proximity of the particular buyer, who belong to the same user group as the particular buyer, etc. Alternatively, the received purchase solicitations may be sent to all the sellers who are registered with the system.

In the same step, product service manager 114 sends the received sale solicitations to the buyers known to the broker. The distribution of the received sale solicitations may be directed to a specific group of buyers, such as the group of buyers who specialize in the particular product or services, who are located in the proximity of the particular seller, who belong to the same user group as the particular seller, etc. Alternatively, the received sale solicitations may be sent to all the buyers who are registered with the system.

The received purchase and sale solicitations may be sent out via email. According to another embodiment, the solicitations may be broadcasted. According to another embodiment, the information about the solicitations may be linked to the specific user accounts and available to the users when they access the system in the future.

In step 450, purchase/service manager 114 receives additional sale solicitations that have been submitted to the broker after purchase/service manager 114 performed the first pass of the matching cycle. The additional sale solicitations may have been submitted in response to the distribution of the received purchase solicitations as described in step 440, or might have been submitted independently form the solicitation distribution described in step 440.

In step 460, purchase/service manager 114 receives additional purchase solicitations that have been submitted to the broker after purchase/service manager 114 performed the first pass of the matching cycle. The additional purchase solicitations may have been submitted in response to the distribution of the received one or more sale solicitations as described in step 440, or might have been submitted independently from the solicitation distribution described in step 440.

In step 470, product/service manager 114 repeats the steps performed in step 430, except this time the additional purchase solicitations and the additional sale solicitations are also taken into consideration in finding a match. In step 470, product/service manager 114 determines whether, for a particular purchase solicitation submitted by the particular buyer, any matching additional sale solicitation may be found. In order to find the match, product/service manager 114 retrieves information about sale solicitations (including the additional sale solicitations found in step 460) submitted to the system and stored in the storage, and verifies whether any of the sale solicitations contains the product/services identified in the particular purchase solicitation. If the match is found, then the match information is sent to the particular buyer who submitted the particular purchase solicitation. The same actions are performed for the particular sale solicitation with respect to finding additional matches, including the additional purchase solicitations found in step 360 that were submitted to the system and stored in the storage.

In step 480, product/service manager 114 advertises (a) each of the particular purchase solicitation from the one or more purchase solicitations and (b) each of the particular sale solicitation from the one or more sale solicitations, regardless of whether the match was found or not. In addition, in step 480, product/service manager 114 advertises the matches found between the purchase solicitations and the sale solicitations.

In one aspect, the advertising functions may be performed cyclically, i.e. during predefined time intervals. The advertisement may be performed by a dedicated process (e.g. a daemon) that performs its tasks according to a predefined scheduled based on the “push-scheme.” According to that scheme, the daemon “pushes” the advertisements to the users at certain times, with certain frequency and according to the queue of advertisements collected during the solicitation processing.

In one aspect, the advertising functions may be performed when the number of newly received solicitations and/or newly identified matches exceeds one or more threshold values.

In one aspect, the advertising functions may be performed upon request by any of the users. This type of advertisement could be implemented according to a “pull” scheme, where an advertisement daemon responds to the users' requests for advertisements by retrieving the advertisements of the solicitations and the matches from an advertisement queue and sends the appropriate advertisements to the user who submitted the requests.

### Advertisement Manager

In one aspect, the solicitations are advertised not by product/service manager 114, but by a separate module, advertisement manager 115. Alternatively, advertisement manager 115 may be a component of product/service manager 114.

Advertisement manager 115 is responsible for advertising information about customers and vendors who use the services of the broker. For example, advertisement manager 115 may advertise the purchase solicitations submitted by the buyers and sale solicitations submitted by the sellers. Advertisement manager 115 may also advertise the categories of the products or services that are in demand and the categories of the products or services that are being offered. Advertisement manager 115 may also advertise the names of the customers that have a well established reputation, are highly rated by other merchants, are considered “trustworthy,” etc.

In one aspect, advertisement manager 115 may provide “trend alert” messages to all or to selected users. A “trend alert” message is a message containing information about the products and/or services that are quite popular and highly desirable at the moment. A “trend alert” message may be sent to the users in a form of an email, or displayed as an advertisement, a banner, an icon, etc. Users may register with the system to receive such alerts, and the alerts would be sent only to those users who requested such notifications. Alternatively, the alerts may be sent to the users selected by the system using various criteria, including the type of solicitations provided by the users, etc.

The “trend alert” message may be generated periodically, for example, every day, every week, etc. Alternatively, the “trend alert” message may be generated when advertisement manager 115 receives a certain number of requests for a particular product or service, or when the number of requests for a particular product or service exceeds a certain threshold value.

Trend alerts may be specific to a particular group of products and/or services. Advertisement manager 115 may generate a separate “trend alert” message for each group of products and each group of services.

In one aspect, advertisement manager 115 may also provide statistical information about the transaction conducted via the broker, the parties involved in the transactions, the products/services transacted during the specified period of time, etc. Additional statistics may include information about unsuccessful transaction, unsuccessful matches, unreliable vendors, poor quality products or services, etc.

Advertisement manager 115 may operate in a “push” mode and/or a “pull” mode, both modes described above.

### Purchase Negotiator

Purchase negotiator 116 is responsible for initiating negotiations between the customers and vendors. Once the information about a match between the purchase solicitation and the sale solicitation is provided to the users, any of the users may decide to accept the match and send, to the broker, a request to initiate the purchase negotiations. In response to receiving such a request, purchase negotiator 116 retrieves the information about the matched purchase and sale solicitations and the involved parties. Purchase negotiator 116 may also retrieve information about the users from their user accounts if such accounts are available.

In one aspect, purchase negotiator 116 assumes the responsibilities of the negotiator acting on behalf of the buyer, the seller or both. The roles may not be specified, and their scope may very.

According to one embodiment, purchase negotiator 116 may only facilitate an exchange of the contact information between the buyer and the seller, while according to another embodiment, purchase negotiator 116 may assist in the transaction between the buyer and the seller until the purchase is completed, product delivered and payment received.

In one aspect, purchase negotiator may provide information to account manager 113 regarding progress of the negotiations between the buyers and the sellers. Purchase negotiator may also provide information to solicitation manager 112 about the buyers and the sellers, about the transactions that have been successfully or unsuccessfully initiated, about feedback received from the buyers and the sellers, etc.

In one aspect, purchase negotiator 116 is a conduit between the users and external agencies that conduct the actual purchase negotiations between the users.

### External Agencies

In one embodiment, the role of purchase negotiator 116 is limited to communicating the details of a particular transaction to one of external agencies 130a . . . , 130m. External agencies 130a . . . , 130m may act as actual brokers between the buyers and the sellers. Examples of such agencies may include eBay Inc., Amazon Inc., Overstock Inc., Priceline Inc., Craigslist Inc., etc.

The users have a choice as to which external agency they would like to use.

Each of the external agencies may be a website or an organization that can create a marketplace other than that created by broker 110.

In one aspect, the user may contact the external agencies directly or using purchase negotiator 116. For example, upon receiving a match representing a particular sale solicitation corresponding to the particular purchase solicitation, any of the respective parties may contact purchase negotiator 116 and request a list of external agencies that could conduct the actual negotiations between the parties. Alternatively, any of the respective parties may contact any of the external agencies on its own, and continue communicating with each other without involving purchase negotiator 116.

### User-Initiated Search

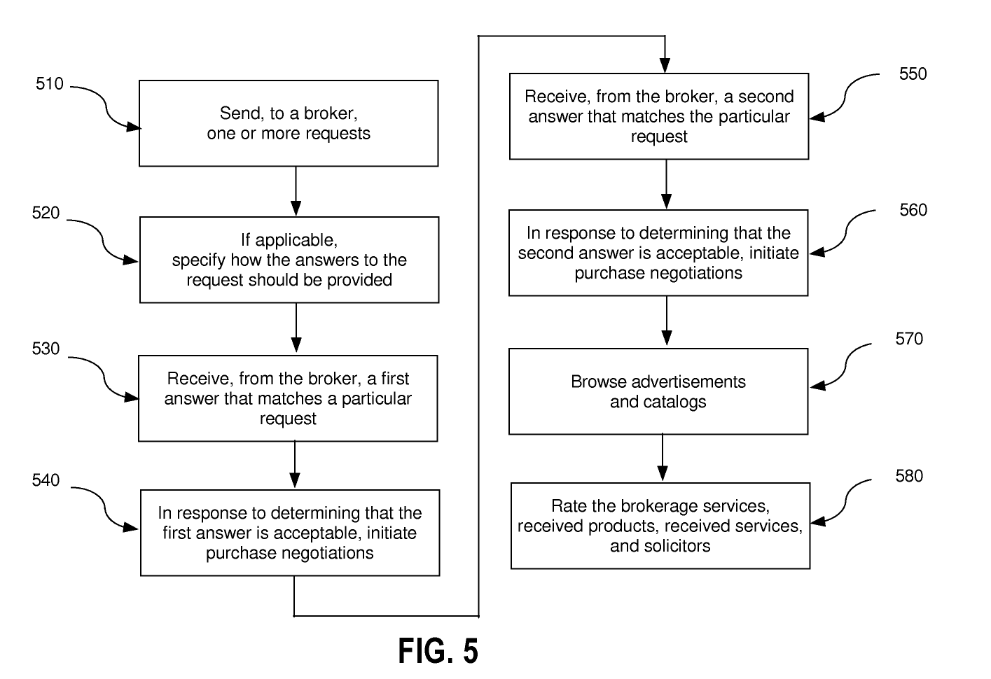

FIG. 5 is a flow diagram that depicts an approach for a user-initiated vendor search, in accordance with an embodiment of the invention. In step 510, a user may enter a solicitation as a free form text, in which the user may specify one or more products or services that the user is either seeking or offering to sell. According to another embodiment, the user may submit the solicitation by sending a file to the broker system or by utilizing any other offline form of communicating with the broker, such as, emails, IM, etc.

In one aspect, the solicitation may be entered online as the user browses a webpage dedicated to the broker. The user may enter an online mode by downloading a page from the website of the broker or by login in to the broker's site.

In step 520, the user may specify how the answer to the user's request should be provided to the user. For example, the user may request that the matches be emailed to the user or sent to the user via Instant Message (IM), or any other form of data communication. Alternatively, the user may request that that the links to the matches be stored in the user's account, if the user already has such an account. Furthermore, the user has an option of defining whether the results should be provided to the user online or offline.

After the user submits the solicitation, in step 530, the user awaits any matches from the system. For example, if the user submitted a purchaser solicitation, then the user may receive, from the broker, one or more matching sale solicitation. Alternatively, or in addition, if the user submitted a sale solicitation, then the user may receive, from the broker, one or more matching purchase solicitations.

In one aspect, the matching response may match the request exactly. For example, if the user requested one hundred iPhones 3GS with 32 GB memory having a black case and manufactured by Apple Inc., preferably supplied by Fry's Electronics, delivered any time but no later than on May 5, 2010, then it is possible that the broker found a seller who offers to sell exactly one hundred iPhones 3GS with 32 GB memory having a black case and manufactured by Apple Inc., supplied by Fry's Electronics, delivered by May 5, 2010.

However, if the broker cannot find an exact match to the particular solicitation, then the broker may attempt to provide partial matches. A partial match is a match where at least one attribute or category from the particular solicitation is matched. For example, if the user requested one hundred iPhones 3GS with 32 GB memory having a black case and manufactured by Apple Inc., preferably supplied by Fry's Electronics, delivered any time but no later than on May 5, 2010, then the broker may find a sale solicitation where the seller offered to sell fifty iPhones 3GS with 32 GB memory having a black case and manufactured by Apple Inc., or another sale solicitation where the seller offered two hundred iPhones 3G manufactured by Apple Inc. but none of other attributes were specified.

In one aspect, the number of partial matches provided to the user may be limited by a threshold that corresponds to the maximum number of matches that can be delivered to the user in one match cycle and defined by the broker. According to another embodiment, the number of particle matches provided to the user may be limited by the number of matching categories, subcategories, or attributes between the request and the match.

In step 540, assuming that the user received at least one match from the broker, the user reviews the matches and determines whether any of them is acceptable to the user. If so, the user may initiate purchase negotiations based on the information included in the received matching solicitations.

The purchase negotiations may be initiated with the broker, using the broker to contact any of the external agencies, or with any of the external agencies directly.

In step 550, the user may receive additional matches to the solicitations submitted by the user. The matches provided this time may be provided to the user as corresponding to the new solicitations submitted to the broker after the first set of matches was delivered to the user in step 530.

The additional matches may be provided to the user online or according to the instructions that the user provided to the broker.

In step 560, assuming that the user received at least one additional match from the broker, the user may review the additional matches and determine whether any of them is acceptable to the user. If so, the user may initiate purchase negotiations based on the information included in the received additional matching solicitations.

In step 570, the user may browse advertisements provided to the broker online of offline. Also, the user may browse the menus and catalogs with products and services available on the broker website and sent to the user by the broker. The user may follow the links included in the advertisements and the menus and submit additional purchase solicitations or sale solicitations.

In step 580, the user has an option of rating the brokerage services, the received products (if any), the received services (if any) and other solicitors with whom the user interacted. The user may enter the rating information as a free form text and have the broker interpret the information. Alternatively, the user may use the broker website and follow the links to identify the product, service or user that the user wants to rate. For example, the user may select a particular seller with whom the user has transacted, and select a rating criteria and values from the menu provided to the user by the broker.

In one aspect the user may provide, to the broker, information about the rating as a measure of confidence level that the user has while interacting with the particular seller. For example, the rating 100% means that other users perceive the particular user as completely reliable and that other users have never complained about the particular user or the transactions conducted with the particular user. In contrast, the rating 0% means that other users do not have confidence in transacting with the particular user.

In one aspect, the user may provide yes/no answer regarding trustworthiness of the particular seller or purchaser. The information about trustworthiness may be entered using a pull-down menu or a toggle displayed for the user.

### Providing Search Results to the Users

In one aspect, the buyer and the seller receive the information about the particular purchase-sale match. For example, if a particular buyer submitted a purchase solicitation for “Vanilla ice-cream near Whitefield, Bangalore, delivered on 15 Aug. 2009,”and the broker identified a particular seller who is willing to sell “Vanilla ice-cream; near Whitefield, Bangalore; on 15 Aug. 2009;” then the match containing the information “Vanilla ice-cream; near Whitefield, Bangalore; on 15 Aug. 2009;” will be sent to both the particular buyer and the particular seller. If in addition, the broker identified an additional sale solicitation from another seller who is willing the sell “Ice-cream; near Whitefield; Bangalore,” the broker will send the additional sale solicitation to both the respective parties even though the particular seller did not specify the variety of the ice-cream and the delivery date.

In one aspect, the search results may be generated using the broker implemented as crawling system that analyzes the information stored in the broker database.

In one aspect, the search results may be displayed to the users in a form of an HTTP page designed to communicate the information about the matches in a concise and informative manner. Alternatively, the search results may be emailed to the users, broadcast to the user or made available to the user at some future time.

The search results may be ranked based on the user preferred ranking, user action with respect to the search results, or any ranking scheme employed by the broker. For example, the search results that the user explored might be ranked higher than the search results that the user has not reviewed. Furthermore, the search results that the user explored recently might be ranked higher than the search results that the user explored in the distant past.

The broker may issue incremental notifications as the new matches are provided to the user. The broker may update the links pertaining to the search results and stored in the user's accounts.

In one aspect, the user may request that the search results be provided to the user at the certain time, or may specify that the user will retrieve the results when it is convenient to the user. The user may place the request any time and update the request so the request reflects the user's needs at the particular moment.

In one aspect, the user may remove the request that the search results be provided to the user, or even delete the previously submitted solicitations.

In one aspect, the user “pulls” the search results form the broker website when it is convenient to the user.

In one aspect, the user is provided with the search results as the broker “pushes” the results to the user. The broker or the user may specify the format of the exported data and the time of the delivery of the search results.

In one aspect, the search results may be displayed as an attachment displayed to the user while the user is chatting, e-mailing, logs in into “myYahoo!” website, etc.

Along with the search results, or independently from the search results, the broker may send to the user various advertisements. The broker may also contact the buyers and sellers to let them know the popular products or services, or the products/services that might be interesting to the buyers or the sellers determined based on the information stored in the user's accounts.

The advertisements may be useful to the user in determining the products/services that are in demand and that are being supplied.

In one aspect, in addition to the search results, the broker may provide to the users a convenient way to contact external agencies that may facilitate negotiations of the “deals.” For example, the broker may provide an interface with external agencies in the form of links to the external agencies websites. The broker may provide electronic links to eBay Inc., Amazon Inc., Overstock Inc. etc.

### Displaying Advertisements

In one aspect, the search results, additional matches and new solicitations may be displayed to the user in a form of an advertisement. For example, if the user is online, then the search results generated by the system, the additional matches generated by the system and/or any additional solicitations submitted by other users may be presented to the user in a form of an advertisement displayed on the user's screen.

The advertisement may be displayed in one of the various forms. For example, the advertisement may be displayed in a form of an icon, a separate window, a button, etc.

The advertisement may be linked to the search results already provided to the user. Alternatively, the advertisements may be linked to the user's profile and/or the user's account.

In one aspect, the user may select the advertisement by “clicking” on the advertisement icon, advertisement window or advertisement button. If the user clicks the advertisement, then the content of the advertisement, including the search results, additional matches or new solicitations, will be open for the viewing.

In one aspect, advertising may be provided free of charge. That means that a particular advertisement is delivered to a particular user without imposing any charge on the individuals whose services are advertised in the particular advertisement and without imposing any charge on the advertisement recipient.

Alternatively, a fee may be imposed on submitting and/or receiving an advertisement. For example, an advertisement fee schedule for advertisers and/or an advertisement fee schedule for advertisement recipients may be implemented. According to the advertisement fee schedule for advertisers, the higher the fee is, the more frequently the advertiser's advertisement is posted and the larger the group of the advertisement recipients is. According to the advertisement fee schedule for advertisement recipients, the higher the fee is, the more “desirable” advertisements are provided to the recipient.

Various criteria for selecting advertisements may be used. For example, the selection of advertisements may be based on the user's requirements, the fee the user paid, the advertiser's reputation, etc.

In one aspect, some of the popular advertisements, containing certain search results, solicitations or “deals,” may be posted on social networks, such as Twitter™.

### Smart Ads—Dynamic Ads

In one aspect, the system may provide not only advertisements containing the requested search results, additional matches and/or additional solicitation, but also various advertisements containing information that the system deduced that may be interesting to the user. These ads may be called “smart ads” or “dynamic ads.”

The smart or dynamic ads may be generated based on the information stored in the user's profile, cookies, etc. For example, the user's profile may include information about the user's age, gender, location, occupation, interests, recently visited websites, etc.

In one aspect, the system may review the user's profile and, based on the user's profile, dynamically generate one or more advertisements about the services and/or products in which the user might be interested even though the user has not yet requested such services and/or products.

The smart and dynamic advertisements may be displayed to the user while the user browses the search result, submits solicitations, browses a website, performs an online search, etc.

### Grouping Result Data

In one aspect, a user may create a number of “buckets” for various search results, and request that search results be distributed to those buckets based on the criteria provided by the user. For example, if the user requested one hundred iPhones 3GS with 32 GB memory having a black case and manufactured by Apple Inc., preferably supplied by Fry's Electronics, then the user may request that all exact matches (that match the request exactly) be stored in “bucket 1,” while all partial matches be stored in “bucket 2.” According to another example, the user may request that all matches that stipulate price $199 or less be stored in “bucket 3,” while all other matches be stored in “bucket 4.”

In one aspect, snapshots of the search results taken at a particular time may be available to the users. The user may specify when and how often the user wants to receive the snapshots. Alternately, the user can opt out from receiving any snapshots.

In one aspect, incremental snapshots may be provided to the user. Parameters for the incremental snapshot may be provided by the user or set to default values by the broker. For example, the user may request receiving incremental snapshots every two months, every year, etc. Implementation of the incremental snapshots may utilize data mining algorithms, etc.

In one aspect, the user may define how the search results should be filtered. For example, the users may request that only exact matches should be delivered, that only matches that match two or more criteria from the request should be delivered, that matches that are provided within one week from the date the request was submitted should be delivered, etc. This can be accomplished by setting filters to customize matching criteria, the time periods for the search results delivery, etc.

The users can also set filters to ignore search results based on various criteria and applied to certain time periods. The broker will apply the filter(s) to the search results generated for the user for determining relevancy of the generated results. For example, the user may specify that the search results (if any) should be delivered every 24 hours, each delivery should be identified as a new “bucket,” and if any request pertains to a group negotiation (which could be performed at different dates), the group deals should linked with each other.

### Types of Deals

In one aspect, a transaction, also referred to as a “deal,” between the users may be characterized as a “one-to-one deal,” an “open-to-the-public deal,” or an “access-controlled deal.”

A “one-to-one deal” is a private deal between a consumer and a vendor. The term “consumer” may refer to one or more physical parties, and by analogy, the term “vendor” may refer to one or more physical party. In the context of the contract law, the consumer may be perceived as a buyer and the vendor may be perceived as a seller, and the buyer as well as the seller may be represented by one ore more individuals, entities, companies, organizations, etc. The details of the “one-to-one deals” are most likely kept private and available only to the involved parties.

In one aspect, an “open-to-the-public deal” is a deal that is not kept private. The details of the “open-to-the-public deal” are available to other users, regardless of whether they are involved in the deal themselves and regardless of whether they have account with account manager 113. The details of the “open-to-the-public deal” may be advertised to other users by advertisement manager 115.

In one aspect, all public deals may be made available to all users, website visitors, etc.

The broker may suggest the public deals to the users and may advertise the public deals to the users. This can be implemented using data mining algorithms. For example, while reviewing the user accounts, the broker may automatically create a column containing information about the public deals in which the user may be interested, or may add the information about the public deals to the search results provided to the user. The information about the public deals may be presented as a “suggestion,” and may be presented to both the buyers and the sellers.

Based on the information pertaining to the public deal data, the broker may create a list of “product & criteria combinations,” that includes public deals paired based on the matching one or more criteria. The “product & criteria combinations” list may be viewed by the users who have user accounts as well as by the users who do not have user accounts. Furthermore, that list may be viewed by the users who are online, and/or may be sent to the users who request that such a list be sent to them offline.

In one aspect, if a particular buyer and a particular seller accept a particular solicitation, then the information about the particular deal may be stored in the buyer account and the seller account. The information about the particular public deal may also be available to an uninvolved party.

Furthermore, if the broker stored another public deal that is similar in terms to the particular public deal, then not only the particular public deal is made available to the uninvolved party, but also the public deals that are similar to the particular public deal are made available to the uninvolved party. Moreover, the uninvolved party may have an option of accepting either of the similar public deals that were made available to the uninvolved party. However, by accepting the public deal, the uninvolved party becomes an involved party, i.e. either a buyer or a seller.

In one aspect, any deal and any solicitation may have a life-span, and other associated characteristics. For example, a deal may have associated expiration time, criteria which when satisfied, cause the expiration of the deal, etc. Furthermore, a deal may expire if the supplier indicates that the supply of products/services specified in the deal has been exhausted, etc.

In one aspect, an “access-controlled deal” is a deal to which access is regulated by broker 110. For example, purchase negotiator 116 of broker 110 may allow only certain users to access the details of the particular “access-controlled deal,” and disallow some other users to access the details of that deal. The purpose of the “access-controlled deals” is to include in the circle of the involved parties some users and exclude from that circle other users. Another purpose of the “access-controlled deals” is to provide the users specializing in transacting specific products with a highly specialized market place accessible only to the selected users.

Various levels of access may be available to the users who have access to a particular “access-controlled deal.” For example, some users may access all the details of the particular transaction, display all the details of the parties that are directly involved in the deal, post comments about the deal and the parties, etc. Some other users may be able to display details of the particular deal, but cannot display the details about the directly involved parties. Yet some other users may be able display some general terms of the deal but not the names of the parties, etc.

### Users Access Control List

In one aspect, the users may be grouped into user groups based on the geographic location of the users, age group, gender, user category (e.g. consumer, vendor) and various other factors. The grouping of the users may be implemented based on the users' accounts and other information that the users provided to the system. The users in the same group may have assigned the same login and password information, and may be authorized with the system using the same authentication and authorization schemes.

In one aspect, the user grouping mechanism can be used to control access to a certain type of deals, referred to as “access-controlled deals.” The “access-controlled-deals” are the deals that are open to the viewers who belong to the particular access control list (ACL). The ACL can also be used to advertise solicitations that might be interesting to the users who belong to the same ACL. For example, if a member of a particular ACL submits a purchase solicitation to broker 110, the purchase solicitation may be also advertised to each of the remaining members of the particular ACL regardless whether they are purchasers or sellers. By analogy, if a member of the particular ACL submits a sale solicitation to broker 110, the sale solicitation may be also advertised to each of the remaining members of the particular ACL regardless of whether they are purchasers or sellers. The disseminations of the solicitations submitted by the members of the same ACL may be implemented as broadcasting, emailing, adding information to the accounts of the members of the same ACL, etc.

### New Product/Service Registration

In one aspect, the users may be presented with an option to register the products/services that users are seeking, offering, or both. The registration may be analogized to a bulletin board, where various users advertise their interests in particular products/services, but do not actually submit purchase and/or sale solicitations. The product/service registration may be an effective marketing tool for the users exploring emerging markets. The registration may be helpful to those who are testing the particular electronic market and try to determine products/services for emerging markets.

In one aspect, the system may use the information provided during the products/services registration process to build a catalog of the products and services that the system can make available to the users.

In one aspect, the process of a new product registration may be supported by an “Automatic Criteria Generator” (ACG). The ACG collects information about a product attributes and configures the product profile according to the collected information. The ACG may display to the user various options and pull-down menus to help the user in describing the product to the system.

Registrations of the new products and services may require entering, into the system, various types of information. That information may be used to generate specifications for potential markets and may be available to the current and potential users.

In one aspect, a user who wants to register a new product may be asked to enter various information about the product, such as the product category, subcategory (or subcategories), model, manufacturer, attributes, preferred supplier, quality, quantity, etc. The information about the new product can be saved in a registration record in storage 140a . . . , 140k.

For example, if the user wants to register iPhones 3GS with 32 GB memory having a black case and manufactured by Apple Inc., preferably supplied by Fry's Electronics, then upon initiating the registration, the system will check whether such iPhones have been already registered with the broker. If such iPhones have not been registered, then the system will prompt the user to enter the following information:

category: electronics

subcategory 1: phone

subcategory 2; iphone

model: iPhone 3GS

manufacturer: Apple Inc.

attribute 1: 3GS

attribute 2: 32 GB

attribute 3: black

preferred supplier: Fry's Electronics, etc.

In one aspect, the system may allow the user to enter the information about the new products as a free form text, and then invokes a parser to generate data entries corresponding to the categories, subcategories, model, manufacturer, attributes, preferred supplier, etc. accordingly. Alternatively, the system will present the user with a sequence of pull-down menus that will prompt the user to enter values in the specific rows of the registration record.

In one aspect, the information about newly registered products and services may be sent individual users and/or groups of users. Alternatively, the information about newly registered products and services may be advertised or broadcast to all users who are online or who are registered with the system.

The information about the newly registered products may be also available to the users offline via various web search features, etc.

In one aspect, various search assistance applications and tools may be available to the users. For example, the system may provide web search tools, a search assistant, etc., to facilitate the search of the products and services that have been registered with the system.

### Billing

In one aspect, the services provided by the broker may be subjected to a payment scheme. Various billing approaches may be implemented. The approaches may be similar to the billing schemes implemented by other e-commerce enterprises and in various e-commerce sites. Alternatively, approaches specific to the broker described herein may be implemented.

Alternatively, the services may be free of charge.

### Broadcasting Solicitations

In one aspect, broadcast and adaptive broadcast approaches are implemented to disseminate solicitations received by the broker. Broadcast may be available for both the buyers and sellers. For example, the sellers may broadcast the products and services that they offering via the e-commerce, while the buyers may broadcast the products and services that are in demand.

In one aspect, the broadcast is performed automatically according to the time settings and time intervals specified by the broker or by the users.

In one aspect, broadcasting is implemented based on a score scheme. According to the score scheme, in the first phase, the solicitations are broadcasted to the users who have the highest ratings. Then, in the second phase, the solicitations are broadcasted to the users who have intermediate ratings. Finally, in the third phase, the solicitations are broadcasted to the users who have fair ratings. For example, a particular solicitation may first broadcast to the users who have scores between 90%-100%. If, upon expiration of a certain time interval, no response was received, then the particular solicitation is broadcast to the users whose scores are between 80%-90%, and so forth.

However, if the number of response received in the first phase exceeds a predetermined threshold value, then the score ranges may be adjusted and the particular solicitation may be first sent to the users whose scores are between 95%-100%, then to the users whose scores are between 90%-95%, and so forth.

In one aspect, the solicitations, matches and users accounts are reviewed and purged if it is necessary. For example, the solicitations may be purged from the system when they expire, the matches may be purged when they are delivered to the users, the accounts may be purged from the system when they expire, etc.

### Negotiations

In one aspect, the broker generates matches between (a) the purchase solicitations submitted by the buyers and (b) sale solicitations submitted by the sellers. The broker assigns a separate object to each of the matches. For example, the broker may consolidate the information about a particular match into one object called a “Required/Available Object.” The broker may make the Object available to both the buyer and the seller. The “Required/Available” object may be used for broadcasting solicitations. For example, by querying the information in the “Required/Available” Object, the user can determine how many users are looking for a particular product, when to broadcast solicitations for a particular product, etc.

The objects corresponding to the solicitations of the same product/service may be grouped in one meta-Object, which can be made available to all the buyers and the sellers who submitted the related solicitations. The users may review the meta- Objects, rate the included matches, delete one or more included matches, comment on one or more included matches, etc. For example, the user may comment which matches fall into a 80%-match category, which matches fall into a 90%-match category, and so forth.

In one aspect, based on the ratings of the matches in meta-Objects, the users may initiate purchase negotiations.

In one aspect, the meta-Objects provide the buyers with the information about the number of sellers who offer to sell the particular product/service, how closely the sellers match the purchase solicitations, etc. Similarly, the meta-Objects provide the sellers with the information about the number of buyers who request the particular product/service, how closely the buyers match the sale solicitation, etc. That information may be used by both the buyers and the sellers to adjust their solicitations, and thus expectations and requirements. Furthermore, that information allows the users to forecast demands/supplies, adjust the planning strategy, pursue emerging markets, etc.

### Implemetation Mechanisms, Alternatives and Extensions

In one aspect, the broker may be implemented as a data store. In such an implementation, various external agencies, users, etc. may provide domain specific information to the broker and request various information from the broker, the data store. Further, the broker may process not only individual solicitations, but groups of solicitations, specialized types of solicitations, etc.

In one aspect, the broker may assume responsibility of conducting the negotiations on behalf of the buyer, the seller or both. For example, if both the buyer and the seller accept the deal, then the buyer and the seller may request that the broker acts as the buyer and the seller agent and undertakes the role of a negotiator until the deal is “closed.” Accordingly, the broker could assume the role currently undertaken by, for example, eBay Inc., Amazon Inc., Overstock Inc., of any other e-commerce dealer.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

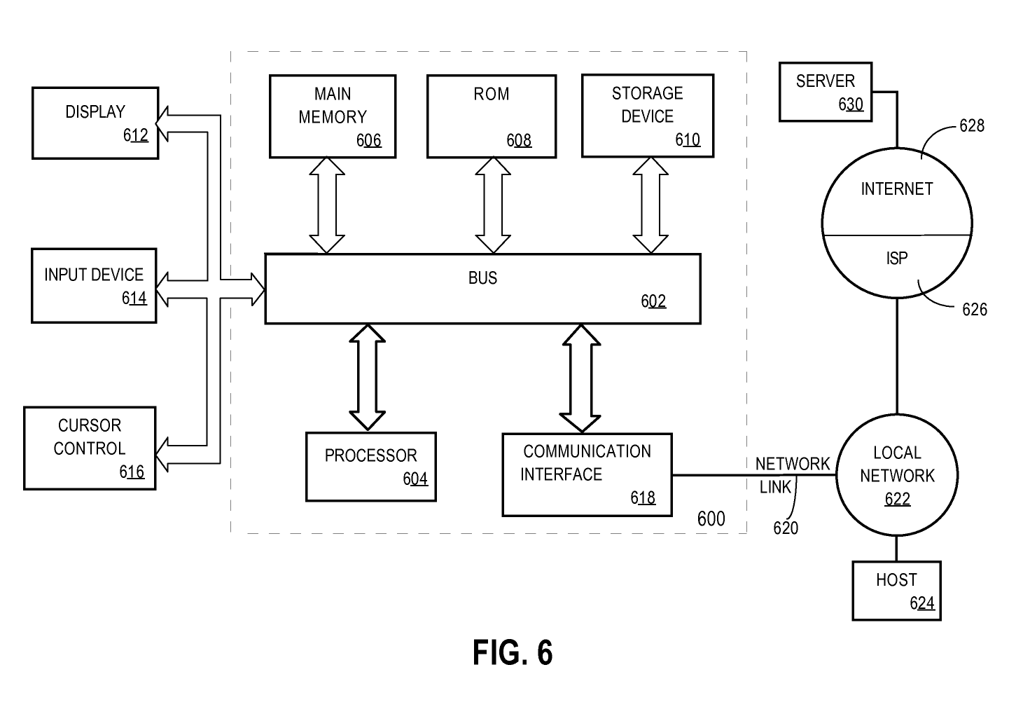

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method for a user-initiated vendor search, the method comprising:
receiving, from one or more buyers of a plurality of buyers, one or more purchase solicitations, and storing the one or more purchase solicitations in a storage;
receiving, from one or more sellers of a plurality of sellers, one or more sale solicitations, and storing the one or more sale solicitations in the storage;
for a particular purchase solicitation of the one or more purchase solicitations:
in response to determining that a first sale solicitation of the one or more sale solicitations, submitted by a first seller, matches the particular purchase solicitation submitted by a particular buyer, providing the first sale solicitations to the particular buyer;
after providing the first sale solicitations to the particular buyer, sending the particular purchase solicitation to the one or more sellers;
in response to receiving, from a second seller of the one or more sellers, a second sale solicitation:
storing the second sale solicitation in the storage;
providing the second sale solicitation to the particular buyer;
for a particular sale solicitation of the one or more sale solicitations:
in response to determining that a first purchase solicitation of the one or more purchase solicitations, submitted by a first buyer, matches the particular sale solicitation submitted by a particular seller, providing the first purchase solicitation to the particular buyer;
after providing the first purchase solicitation to the particular buyer, sending the first sale solicitation to the one or more buyers;
in response to receiving, from a second buyer of the one or more buyers, a second purchase solicitation:
storing the second purchase sale solicitation in the storage;
providing the second purchase solicitation to the particular seller.

2. The method of claim 1, further comprising:
providing browsing capabilities to the one or more buyers and to the one or more sellers of solicitations submitted by the one or more buyers and the one or more sellers;
initiating purchase negotiations between the one or more buyers and the one or more sellers.

3. The method of claim 1, wherein each of the purchase solicitations comprises information about at least one requested product or service and information about attributes of the requested product or service, and wherein each of the sale solicitations comprises information about at least one offered product or service and information about attributes of the offered product or service.

4. The method of claim 1, wherein the particular purchase solicitation comprises a free form text, and wherein the particular sale solicitation comprises a free form text.

5. The method of claim 1, wherein the first and the second sale solicitations are provided to the particular buyer online or offline, and wherein the first and the second purchase solicitations are provided to the particular seller online or offline.

6. The method of claim 1, further comprising:
advertising the one or more purchase solicitations to the one or more buyers and to the one or more sellers;
advertising the one or more sale solicitations to the one or more buyers and to the one or more sellers.

7. One or more storage media storing instructions which, when executed by one or more computing devices, cause performance of the method recited in claim 1.

8. One or more storage media storing instructions which, when executed by one or more computing devices, cause performance of the method recited in claim 2.

9. One or more storage media storing instructions which, when executed by one or more computing devices, cause performance of the method recited in claim 3.

10. One or more storage media storing instructions which, when executed by one or more computing devices, cause performance of the method recited in claim 4.

11. One or more storage media storing instructions which, when executed by one or more computing devices, cause performance of the method recited in claim 5.

12. One or more storage media storing instructions which, when executed by one or more computing devices, cause performance of the method recited in claim 6.

13. A method for a user-initiated vendor search, the method comprising:
sending, to a broker, one or more requests;
for a particular request of the one or more requests:
receiving, from the broker, a first answer that matches the particular request;
wherein the first answer was submitted to the broker by a first solicitor of one or more solicitors before the particular request was received by the broker;
in response to determining that the first answer is acceptable, initiating purchase negotiations, via the broker, with the first solicitor;
after receiving the first answer, receiving, from the broker, a second answer that matches the particular request;
wherein the second answer was submitted to the broker by a second solicitor of the one or more solicitors after the particular request was received by the broker;
in response to determining that the second answer is acceptable, initiating purchase negotiations, via the broker, with the second solicitor.

14. The method of claim 13, further comprising:
browsing one or more additional answers solicited to the broker by the one or more solicitors;
selecting, from the one or more additional answers, a third answer that was submitted by a third solicitor of the one or more solicitors; and
in response to determining that the third answer is acceptable, initiating purchase negotiations, via the broker, with the third solicitor.

15. The method of claim 13, wherein each of the one or more requests comprises information about at least one requested product or service and information about attributes of the requested product or service, and wherein each of the answers comprises information about at least one offered product or service and information about attributes of the offered product or service.

16. The method of claim 13, wherein the particular request comprises a free form text.

17. The method of claim 13, wherein the first, the second and the third answers are provided online or offline.

18. One or more storage media storing instructions which, when executed by one or more computing devices, cause performance of the method recited in claim 13.

19. One or more storage media storing instructions which, when executed by one or more computing devices, cause performance of the method recited in claim 14.

20. One or more storage media storing instructions which, when executed by one or more computing devices, cause performance of the method recited in claim 15.

21. One or more storage media storing instructions which, when executed by one or more computing devices, cause performance of the method recited in claim 16.

22. One or more storage media storing instructions which, when executed by one or more computing devices, cause performance of the method recited in claim 17.
